(19) United States
(12) Patent Application Publication
(10) Pub. No.: US 2026/0253521 A1
(43) Pub. Date: Aug. 27, 2026

(54) DRIVE CIRCUIT AND ELECTRO-OPTICAL DEVICE

(71) Applicant: SEIKO EPSON CORPORATION, Tokyo (JP)

(72) Inventors: Akira MORITA, CHINO-SHI (JP); Ryota BANSHO, MATSUMOTO-SHI (JP)

(73) Assignee: SEIKO EPSON CORPORATION, Tokyo (JP)

(21) Appl. No.: 19/550,316

(22) Filed: Feb. 26, 2026

(30) Foreign Application Priority Data
Feb. 27, 2025 (JP) 2025-029872

(51) Int. Cl. G09G 3/00

(52) U.S. Cl. CPC G09G 3/006; G09G 2300/0426; G09G 2330/12

(57) ABSTRACT

A drive circuit includes: an output node; a first switch having one end electrically coupled to the output node; n first capacitors each having one end electrically coupled to the other end of the first switch and the other end electrically coupled to a first capacitor drive circuit; a second switch having one end electrically coupled to the other end of the first switch and the other end electrically coupled to a first test node; a third switch having one end electrically coupled to the output node; a balance capacitance circuit electrically coupled to the other end of the third switch; and a fifth switch having one end electrically coupled to the other end of the third switch and the other end electrically coupled to a second test node.

The present application is based on, and claims priority from JP Application Serial Number 2025-029872, filed February 27, 2025, the disclosure of which is hereby incorporated by reference herein in its entirety.

### BACKGROUND

### 1. Technical Field

The present disclosure relates to a drive circuit and an electro-optical device including the drive circuit.

### 2. Related Art

In the related art, a driver is known in which a drive circuit that supplies a data voltage corresponding to gradation data to an electro-optical panel is mounted. For example, JP-A-2016-80807 describes a driver including a voltage drive circuit that outputs a data voltage corresponding to gradation data, and a capacitance drive circuit that includes first to n-th capacitors and first to n-th capacitor drive circuits corresponding to the gradation data and that outputs first to n-th capacitor drive voltages.

The driver in JP-A-2016-80807 further includes a variable capacitance circuit including m capacitors and m switches. The variable capacitance circuit is used to set a capacitance on a driven side obtained by adding a capacitance of the variable capacitance circuit and an electro-optical panel-side capacitance and capacitances of the first to n-th capacitors to a given capacitance ratio relationship.

JP-A-2016-80807 is an example of the related art.

In JP-A-2016-80807, the first to n-th capacitors have capacitance values weighted by a power of 2. That is, with respect to the number of bits of the gradation data, the first to n-th capacitors have a capacitance ratio of the number of bits or more. For example, when the gradation data is 12 bits, the capacitor of the most significant bit (MSB) and the capacitor of the least significant bit (LSB) have a capacitance ratio of 2^12 or more. Therefore, when the capacitors are driven at, for example, 15 V, a voltage change of 7.5 V occurs when the capacitor corresponding to the most significant bit is driven, whereas a voltage change of only 3.7 mV occurs when the capacitor corresponding to the least significant bit is driven. That is, since the voltage change when the capacitor corresponding to the least significant bit is driven is fairly small with respect to the voltage change when the capacitor corresponding to the most significant bit is driven, it may be difficult to secure the inspection accuracy when the first to n-th capacitors are inspected by the voltage change.

In the inspection of the first to n-th capacitors, the influence of the capacitance of the variable capacitance circuit is also a problem.

### SUMMARY

A drive circuit according to an aspect of the present application includes: an output node electrically coupled to a pixel; a first switch having one end electrically coupled to the output node; n (n is an integer of 1 or more) first capacitors each having one end electrically coupled to the other end of the first switch; a first capacitor drive circuit configured to drive the n first capacitors based on a video signal representing image information and electrically coupled to the other end of each of the n first capacitors; a second switch having one end electrically coupled to the other end of the first switch and the other end electrically coupled to a first test node; a third switch having one end electrically coupled to the output node; m (m is an integer of 1 or more) fourth switches each having one end electrically coupled to the other end of the third switch; m second capacitors each having one end electrically coupled to the other end of a respective one of the m fourth switches and the other end to which a constant potential is applied; and a fifth switch having one end electrically coupled to the other end of the third switch and the other end electrically coupled to a second test node.

A drive circuit according to an aspect of the present application includes: an output node electrically coupled to a pixel; a seventh switch having one end electrically coupled to the output node; s (s is an integer of 1 or more) third capacitors each having one end electrically coupled to the other end of the seventh switch; a second capacitor drive circuit configured to drive the s third capacitors based on a video signal of a lower bit of a video signal representing image information and electrically coupled to the other end of each of the s third capacitors; an eighth switch having one end electrically coupled to the other end of the seventh switch and the other end electrically coupled to a third test node; a ninth switch having one end electrically coupled to the output node; n-s (n is an integer larger than s) fourth capacitors each having one end electrically coupled to the other end of the ninth switch; a third capacitor drive circuit configured to drive the n-s fourth capacitors based on a video signal of an upper bit of the video signal representing the image information and electrically coupled to the other end of each of the n-s fourth capacitors; a tenth switch having one end electrically coupled to the other end of the ninth switch and the other end electrically coupled to a fourth test node; a third switch having one end electrically coupled to the output node; m (m is an integer of 1 or more) fourth switches each having one end electrically coupled to the other end of the third switch; m second capacitors each having one end electrically coupled to the other end of a respective one of the m fourth switches and the other end to which a constant potential is applied; and a fifth switch having one end electrically coupled to the other end of the third switch and the other end electrically coupled to a second test node.

A drive circuit according to an aspect of the present application includes:

an output node electrically coupled to a pixel;

a seventh switch having one end electrically coupled to the output node;

s (s is an integer of 1 or more) third capacitors each having one end electrically coupled to the other end of the seventh switch;

a second capacitor drive circuit configured to drive the s third capacitors based on a video signal of a lower bit of a video signal representing image information and electrically coupled to the other end of each of the s third capacitors;

an eighth switch having one end electrically coupled to the other end of the seventh switch and the other end electrically coupled to a third test node;

a ninth switch having one end electrically coupled to the output node;

n-s (n is an integer larger than s) fourth capacitors each having one end electrically coupled to the other end of the ninth switch;

a third capacitor drive circuit configured to drive the n-s fourth capacitors based on a video signal of an upper bit of the video signal representing the image information and electrically coupled to the other end of each of the n-s fourth capacitors;

a tenth switch having one end electrically coupled to the other end of the ninth switch and the other end electrically coupled to a fourth test node;

an eleventh switch having one end electrically coupled to the output node;

p (p is an integer of 1 or more) twelfth switches each having one end electrically coupled to the other end of the eleventh switch;

p fifth capacitors each having one end electrically coupled to the other end of a respective one of the p twelfth switches and the other end to which a constant potential is applied;

a thirteenth switch having one end electrically coupled to the other end of the twelfth switch and the other end electrically coupled to a fifth test node;

a fourteenth switch having one end electrically coupled to the output node;

m-p (m is an integer larger than p) fifteenth switches each having one end electrically coupled to the other end of the fourteenth switch;

m-p sixth capacitors each having one end electrically coupled to the other end of a respective one of the m-p fifteenth switches and the other end to which a constant potential is applied; and

a sixteenth switch having one end electrically coupled to the other end of the fifteenth switch and the other end electrically coupled to a sixth test node.

An electro-optical device according to an aspect of the present application includes the drive circuit described above and an electro-optical panel including the pixel and electrically coupled to the output node.

### BRIEF DESCRIPTION OF THE DRAWINGS

FIG. 1 is a perspective view showing an appearance of an electro-optical device including a drive circuit according to the embodiment.

FIG. 2 is a block diagram showing a schematic configuration of the drive circuit.

FIG. 3 is a circuit diagram of the drive circuit.

FIG. 4 is a timing chart showing an operation during inspection in a configuration according to a comparative example.

FIG. 5 is a timing chart showing an operation during inspection in a configuration according to the embodiment.

FIG. 6 is a circuit diagram of a drive circuit according to Embodiment 2.

FIG. 7 is a timing chart showing an operation during inspection of the drive circuit according to Embodiment 2.

FIG. 8 is a circuit diagram of a drive circuit according to Modification 1 of Embodiment 2.

FIG. 9 is a circuit diagram of a drive circuit according to Modification 2 of Embodiment 2.

FIG. 10 is a circuit diagram of a drive circuit according to Embodiment 3.

FIG. 11 is a timing chart showing an operation during inspection of the drive circuit according to Embodiment 3.

FIG. 12 is a circuit diagram of a drive circuit according to Embodiment 4.

FIG. 13 is a timing chart showing an operation of the drive circuit according to Embodiment 4.

### DESCRIPTION OF EMBODIMENTS

An embodiment of the present disclosure will hereinafter be described with reference to the drawings.

### 1. Embodiment 1

### 1.1. Configuration of Electro-Optical Device 100

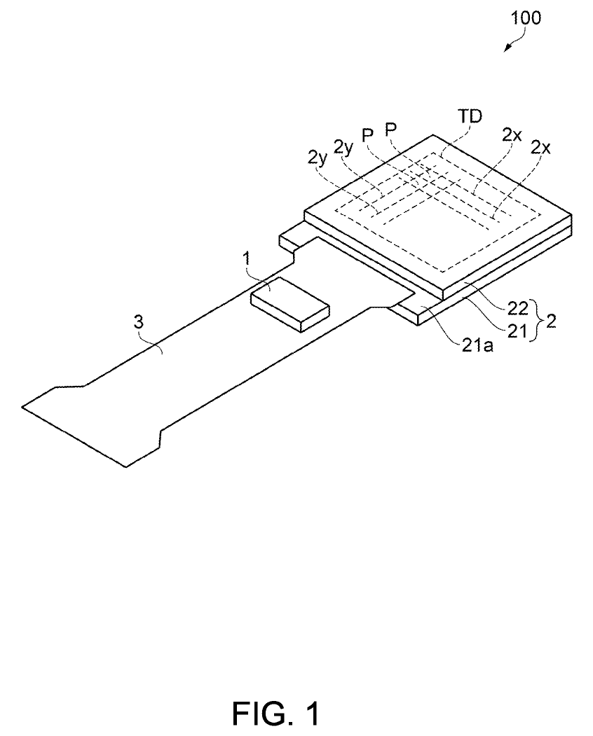

FIG. 1 is a perspective view showing an example of an appearance of an electro-optical device 100 according to the embodiment.

As shown in FIG. 1, the electro-optical device 100 includes a driver 1, an electro-optical panel 2, and a flexible substrate 3.

The electro-optical device 100 is preferably used as a display device of a projector. The electro-optical device 100 may be used as a display device of a smartphone, a camera, a television, a car navigation device, a personal computer, a display, a point of sale (POS) terminal, a printer, a scanner, a copier, a video player, or an apparatus including a touch panel.

The electro-optical panel 2 is an active drive type transmissive liquid crystal display panel including pixels P in a display region TD and a thin film transistor (TFT) as a switching element for each pixel P. The electro-optical panel 2 may be a reflective liquid crystal display panel or a transflective liquid crystal display panel.

The pixels P are provided corresponding to intersections of scanning lines 2x and data lines 2y provided in a matrix. The electro-optical panel 2 includes an element substrate 21 and a counter substrate 22, and the flexible substrate 3 is mounted on a protruding portion 21a of the element substrate 21.

The driver 1 outputs a data voltage Vd for driving the electro-optical panel 2 to the electro-optical panel 2 based on a video signal representing image information. In the embodiment, the driver 1 includes an integrated circuit device (IC). The integrated circuit device is, for example, an IC chip in which a circuit is formed at a silicon substrate, or a device in which an IC chip is housed in a package. In the embodiment, the driver 1 is an example of a drive circuit.

In the embodiment, the driver 1 is mounted on the flexible substrate 3. That is, the data voltage Vd output from the driver 1 is supplied to the electro-optical panel 2 via the flexible substrate 3. The driver 1 may be mounted on the protruding portion 21a of the electro-optical panel 2, or may be mounted on a rigid substrate (not illustrated) to supply the data voltage Vd to the electro-optical panel 2 via the flexible substrate 3.

The data voltage Vd, a power supply voltage, a timing signal, and the like are supplied to the electro-optical panel 2 via the flexible substrate 3. Alternatively, a part or all of the power supply voltage, the timing signal, and the like may be output by the driver 1.

### 1.2. Configuration of Driver 1

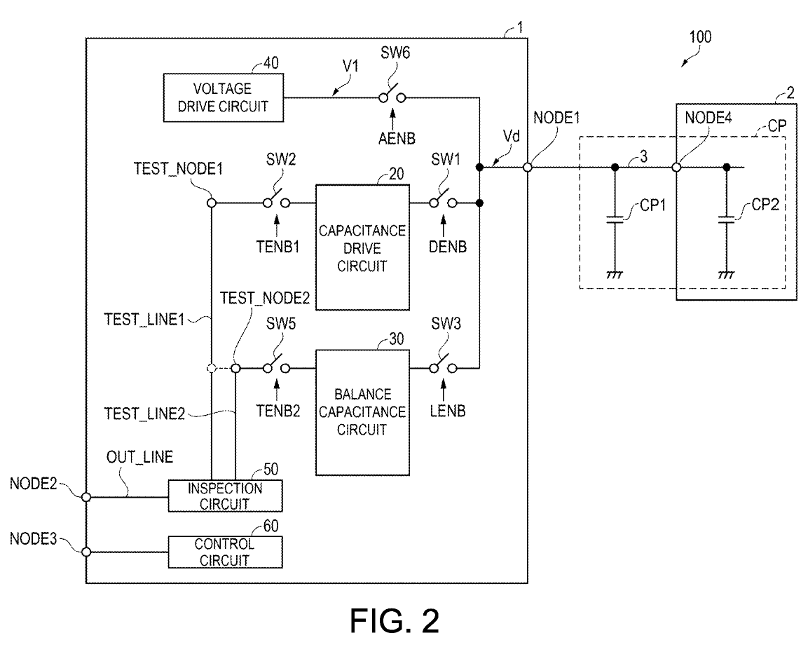

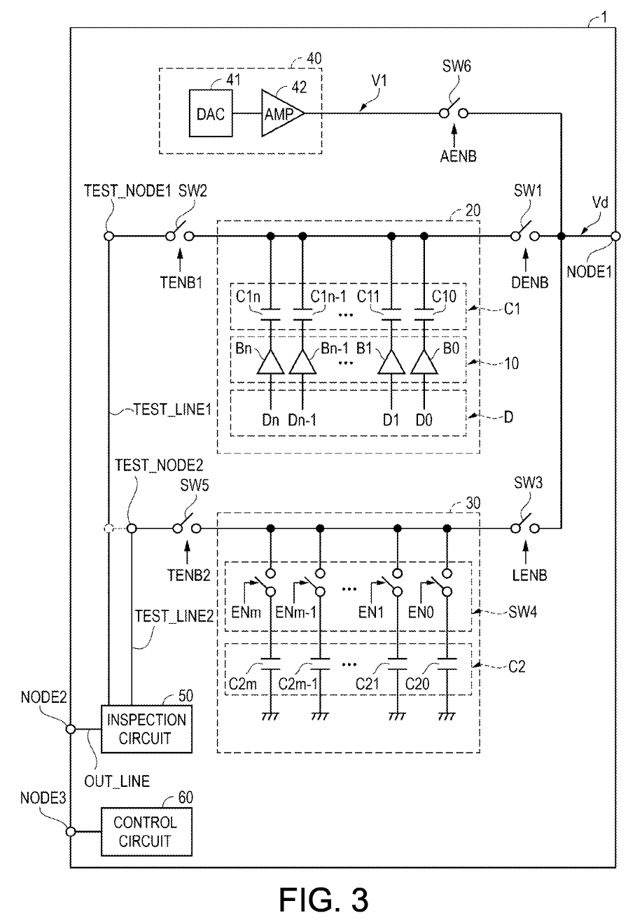

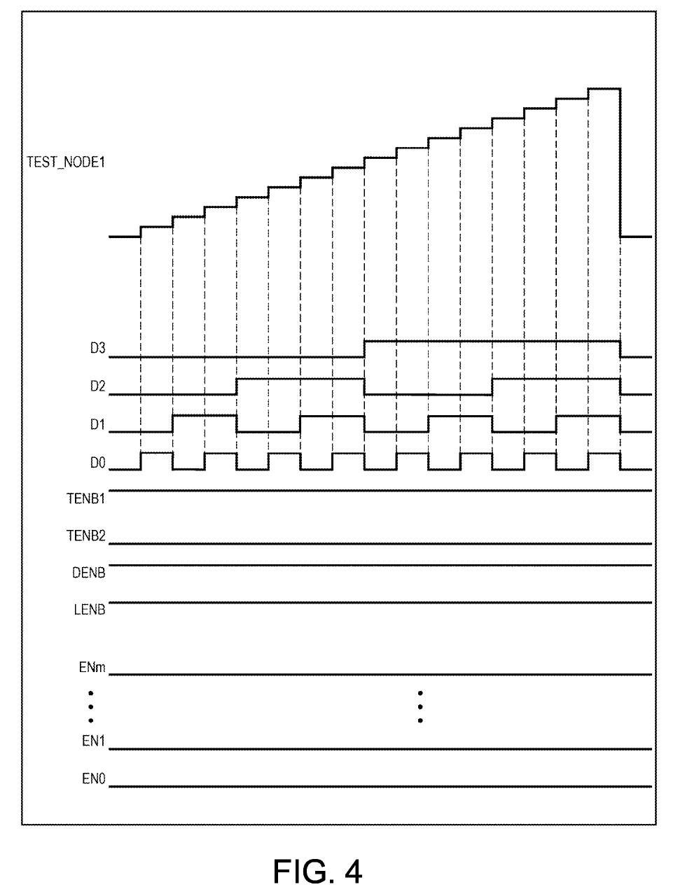

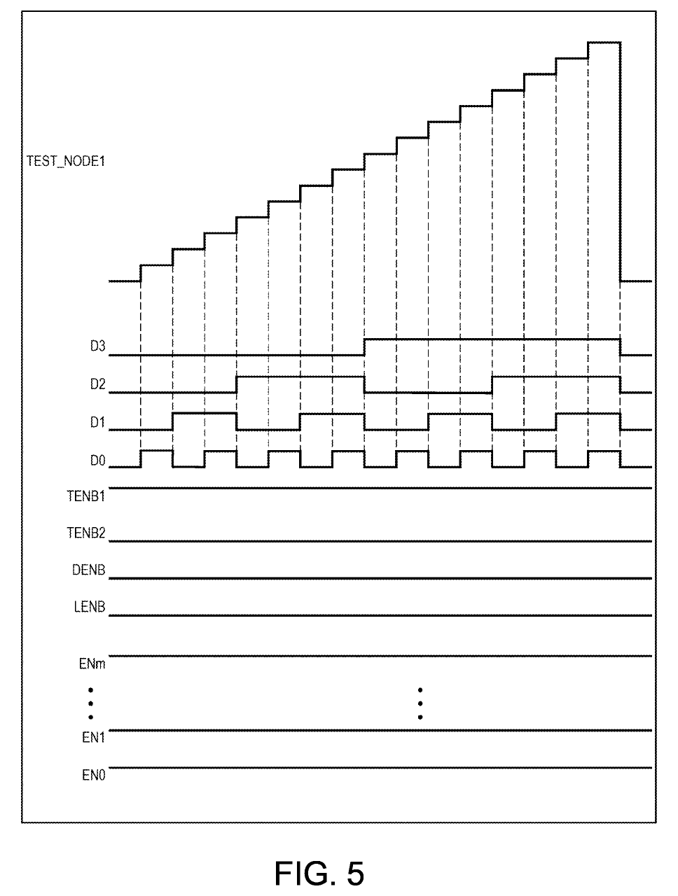

FIG. 2 is a block diagram showing a schematic configuration of the driver 1. FIG. 3 is a circuit diagram of the driver 1. FIG. 4 is a timing chart showing an operation of the driver 1. FIG. 5 is a timing chart showing the operation of the driver 1.

The driver 1 includes a capacitance drive circuit 20, a balance capacitance circuit 30, a voltage drive circuit 40, an inspection circuit 50, a control circuit 60, and an output node NODE1 which is an output terminal for outputting the data voltage Vd.

The capacitance drive circuit 20 outputs the data voltage Vd by charge redistribution of a capacitor.

The balance capacitance circuit 30 is used for appropriately driving various electro-optical panels 2 having different electro-optical panel-side capacitances CP.

The voltage drive circuit 40 outputs a first voltage V1 based on a video signal representing image information as the data voltage Vd.

The capacitance drive circuit 20 is electrically coupled to the output node NODE1 via a switch SW1. The balance capacitance circuit 30 is electrically coupled to the output node NODE1 via a switch SW3. The voltage drive circuit 40 is electrically coupled to the output node NODE1 via a switch SW6. In the embodiment, the switch SW1 is an example of a first switch, the switch SW3 is an example of a third switch, and the switch SW6 is an example of a sixth switch.

When the driver 1 drives the electro-optical panel 2, the switch SW1 and the switch SW3 are turned on in a first period, and are turned off in a second period after the first period. In contrast, the switch SW6 is turned off in the first period, and is turned on in the second period after the first period. That is, the driver 1 outputs the data voltage Vd by capacitive driving by the capacitance drive circuit 20 in the first period, and outputs the data voltage Vd by voltage driving by the voltage drive circuit 40 in the second period after the first period. Under the control, it is possible to drive the driver 1 at a high speed with high accuracy.

A control signal DENB is supplied from the control circuit 60 to the control terminal of the switch SW1, a control signal LENB is supplied from the control circuit 60 to the control terminal of the switch SW3, and a control signal AENB is supplied from the control circuit 60 to the control terminal of the switch SW6. That is, on/off of the switch SW1, the switch SW3, and the switch SW6 is controlled by the control circuit 60.

The capacitance drive circuit 20 is electrically coupled to a test node TEST_NODE1 via a switch SW2. The balance capacitance circuit 30 is electrically coupled to a test node TEST_NODE2 via a switch SW5. That is, the capacitance drive circuit 20 and the balance capacitance circuit 30 are coupled to different test nodes. Therefore, since the driver 1 can inspect the capacitance drive circuit 20 and the balance capacitance circuit 30 in parallel, the inspection speed can be increased. In the embodiment, the switch SW2 is an example of a second switch, and the switch SW5 is an example of a fifth switch. The balance capacitance circuit 30 may be electrically coupled to the test node TEST_NODE1 via the switch SW5. Since the configuration of the circuit such as wiring can be reduced, miniaturization and cost reduction can be achieved.

The test node TEST_NODE1 is electrically coupled to the inspection circuit 50 via a test line TEST_LINE1. The test node TEST_NODE2 is electrically coupled to the inspection circuit 50 via a test line TEST_LINE2.

The inspection circuit 50 is a circuit that inspects the accuracy of the capacitance drive circuit 20 and the balance capacitance circuit 30. The inspection result obtained by the inspection circuit 50 is output to an inspection result output node NODE2 via an output line OUT_LINE. Based on the inspection result obtained by the inspection circuit 50, it is possible to know the quality of the capacitance drive circuit 20 and the balance capacitance circuit 30, the occurrence of defects, and the like.

The inspection circuit 50 is preferably formed at the same silicon substrate as the capacitance drive circuit 20 and the balance capacitance circuit 30, and the inspection circuit 50 can be formed at low cost on the same silicon substrate. The driver 1 may not include the inspection circuit 50.

When the inspection circuit 50 inspects the capacitance drive circuit 20, the switch SW2 is turned on and the switch SW1 is turned off. That is, since the capacitance drive circuit 20 is separated from the output node NODE1, the influence of the output node NODE1, for example, the influence of a voltage change or parasitic capacitance can be eliminated when the capacitance drive circuit 20 is inspected, and thus the inspection accuracy can be improved. Further, the switch SW3 is turned off. Since the influence of the balance capacitance circuit 30 can be eliminated by turning off the switch SW3, the inspection accuracy can be improved.

When the inspection circuit 50 inspects the balance capacitance circuit 30, the switch SW5 is turned on and the switch SW3 is turned off. That is, since the balance capacitance circuit 30 is separated from the output node NODE1, it is possible to eliminate the influence of the output node NODE1, for example, the influence of a voltage change or parasitic capacitance when the balance capacitance circuit 30 is inspected. Further, the switch SW1 is turned off. Since the influence of the capacitance drive circuit 20 can be eliminated by turning off the switch SW2, the inspection accuracy can be improved.

In this way, according to the embodiment, since the influence of the output node NODE1 and the influence of the balance capacitance circuit 30 can be eliminated when the capacitance drive circuit 20 is inspected, the amplitude of the inspection voltage can be increased. Similarly, since the influence of the output node NODE1 and the influence of the capacitance drive circuit 20 can be eliminated when the balance capacitance circuit 30 is inspected, the amplitude of the inspection voltage can be increased. Therefore, according to the embodiment, it is possible to improve the accuracy of the inspection of the capacitance drive circuit 20 or the inspection of the balance capacitance circuit 30 by the inspection circuit 50.

A control signal TENB1 is supplied from the control circuit 60 to the control terminal of the switch SW2, and a control signal TENB2 is supplied from the control circuit 60 to the control terminal of the switch SW5. That is, on/off of the switch SW2 and the switch SW5 is controlled by the control circuit 60.

The control circuit 60 is coupled to an input/output node NODE3. The control circuit 60 executes various types of control described above based on control information stored in a memory (not illustrated). The control information can be set or changed from the outside via the input/output node NODE3.

### 1.2.1. Configuration of Capacitance Drive Circuit 20

The capacitance drive circuit 20 is a circuit that outputs the data voltage Vd by charge redistribution of the capacitor. The capacitance drive circuit 20 outputs the data voltage Vd to the output node NODE1 via the switch SW1 having one end electrically coupled to the output node NODE1.

As shown in FIG. 3, the capacitance drive circuit 20 includes n capacitors C1 and a capacitor drive circuit 10 that drives the n capacitors C1 based on a video signal representing image information. Here, n is an integer of 1 or more, and for example, n may be set to the same number as the number of bits of the gradation data D. In the embodiment, the n capacitors C1 are an example of n first capacitors, and the capacitor drive circuit 10 is an example of a first capacitor drive circuit.

The n capacitors C1 include capacitors C10, C11, ..., C1n-1, and C1n. One end of each of the n capacitors C1 is electrically coupled to the other end of the switch SW1.

The capacitor drive circuit 10 includes n drive units B0, B1, ..., Bn-1, and Bn. One end of each of the n drive units B0, B1, ..., Bn-1, and Bn of the capacitor drive circuit 10 is electrically coupled to the other end of a respective one of the n capacitors C1.

Each of capacitance values of the capacitors C10, C11, ..., C1n-1, and C1n is weighted by a power of 2 corresponding to a respective one of digits of the bits D0, D1, ..., Dn-1, and Dn of the gradation data D. The drive units B0, B1, ..., Bn-1, and Bn output a low-level or high-level potential according to the bits D0, D1, ..., Dn-1, and Dn, so that the capacitors C10, C11, ..., C1n-1, and C1n are driven by the potential. The low-level potential is, for example, 0 V, and the high-level potential is, for example, 15 V. In the embodiment, the gradation data D is an example of a video signal representing image information.

By this driving, charge redistribution occurs between the capacitors C10, C11, ..., C1n-1, and C1n and the electro-optical panel-side capacitance CP (see FIG. 2), and as a result, the data voltage Vd is output to the output node NODE1. The electro-optical panel-side capacitance CP is determined by a substrate capacitance CP1 and a panel capacitance CP2.

The electro-optical panel-side capacitance CP is the sum of capacitances seen from the output node NODE1. For example, the electro-optical panel-side capacitance CP is obtained by adding the substrate capacitance CP1 which is a parasitic capacitance of the flexible substrate 3 and the panel capacitance CP2 which is a parasitic capacitance or a pixel capacitance in the electro-optical panel 2. The TFT in the electro-optical panel 2 has a parasitic capacitance between the source and the gate. Since a large number of TFTs are coupled to the data lines 2y (see FIG. 1), the parasitic capacitances of the large number of TFTs are attached to the data lines 2y. Parasitic capacitances are present between the data lines 2y and the scanning lines 2x. In the liquid crystal display panel, the pixel P has a capacitance. The sum of these capacitances is the panel capacitance CP2.

### 1.2.2. Configuration of Balance Capacitance Circuit 30

In the embodiment, the driver 1 includes the balance capacitance circuit 30.

The balance capacitance circuit 30 is a circuit which is a capacitance coupled to the output node NODE1 via the switch SW3 and whose capacitance value can be variably set, and is a circuit corresponding to the variable capacitance circuit described in JP-A-2016-80807.

The balance capacitance circuit 30 includes m switches SW4 and m capacitors C2 for capacitance adjustment. Here, m is an integer of 1 or more.

One end of each of the m switches SW4 is electrically coupled to the other end of the switch SW3. Control signals EN0, EN1, ..., ENm-1, and ENm are each supplied from the control circuit 60 to a respective one of the control terminals of the m switches SW4. In the embodiment, the m switches SW4 are an example of m fourth switches.

The m capacitors C2 include capacitors C20, C21, ..., C2m-1, and C2m. Each of capacitance values of the capacitors C20, C21, ..., C2m-1, and C2m has a capacitance value weighted by a power of 2. One end of each of the m capacitors C2 is electrically coupled to the other end of a respective one of the m switches SW4, the other end of each of the m capacitors C2 is coupled to a node of a reference potential, and a constant potential which is the reference potential is applied. In the embodiment, the m capacitors C2 are an example of m second capacitors.

The balance capacitance circuit 30 is used to set the capacitance ratio between the capacitance (the sum of the capacitances of the capacitors C10, C11, ..., C1n-1, and C1n) of the n capacitors C1 and the electro-optical panel-side capacitance CP to a predetermined value. With the balance capacitance circuit 30, the driver 1 can appropriately drive various electro-optical panels 2 having different electro-optical panel-side capacitances CP, and the versatility of the driver 1 can be increased.

In the embodiment, the capacitors C10, C11, ..., C1n-1, and C1n and the capacitors C20, C21, ..., C2m-1, and C2m are capacitances incorporated in the integrated circuit device, and can be implemented by, for example, metal insulation metal (MIM) capacitors.

### 1.2.3. Configuration of Voltage Drive Circuit 40

The voltage drive circuit 40 includes a digital to analog converter (DAC) 41 and an amplifier 42.

The DAC 41 generates and outputs a reference voltage (a gradation voltage) corresponding to each value of the gradation data D. When the gradation data D is, for example, 12 bits, 4096 levels of reference voltages are generated and output.

The amplifier 42 amplifies the reference voltage output from the DAC 41 and outputs the first voltage V1. The first voltage V1 is output as the data voltage Vd from the output node NODE1 via the switch SW6.

### 1.3. Description of Operation During Inspection Based on Timing Chart

Next, the operation of the capacitance drive circuit 20 during inspection will be described with reference to the timing charts of FIGS. 4 and 5.

FIG. 4 is a timing chart showing an operation during inspection in a configuration according to a comparative example. Here, the configuration according to the comparative example is a configuration showing the influence of the output node NODE1 during inspection, and is a configuration in which the switch SW1 and the switch SW3 are turned on. FIG. 5 is a timing chart showing an operation during inspection in a configuration according to the embodiment.

As shown in FIG. 4, when the capacitance drive circuit 20 is inspected as the configuration according to the comparative example, the switch SW1, the switch SW3, and the switch SW2 are turned on and the switch SW5 is turned off from the start to the end of the inspection. Therefore, the control signal DENB, the control signal LENB, and the control signal TENB1 are set to the high level, and the control signal TENB2 is set to the low level. The control signals EN0, EN1, ..., ENm-1, and ENm of the m switches SW4 of the balance capacitance circuit 30 are set to the low level. In this way, in the comparative example, when the capacitance drive circuit 20 is inspected, the balance capacitance circuit 30 is electrically coupled to the output node NODE1.

As shown in FIG. 5, in the configuration according to the embodiment, when the capacitance drive circuit 20 is inspected, the switch SW2 is turned on and the switch SW1, the switch SW3, and the switch SW5 are turned off from the start to the end of the inspection. Therefore, the control signal TENB1 is set to the high level, and the control signal DENB, the control signal LENB, and the control signal TENB2 are set to the low level. In this way, in the embodiment, when the capacitance drive circuit 20 is inspected, the balance capacitance circuit 30 is electrically separated from the output node NODE1. The balance capacitance circuit 30 may be inspected simultaneously with the capacitance drive circuit 20. In this case, the switch SW3 is turned off, the switch SW5 is turned on, the control signal TENB2 is set to the high level, and the control signal LENB is set to the low level. When the capacitance drive circuit 20 and the balance capacitance circuit 30 are simultaneously inspected by the inspection circuit 50, the inspection circuit 50 may include a first inspection circuit that inspects the capacitance drive circuit 20 and a second inspection circuit that inspects the balance capacitance circuit 30.

When the inspection of the capacitance drive circuit 20 is started, the capacitance drive circuit 20 is sequentially driven based on the gradation data D. The drive units B0, B1, ..., Bn-1, and Bn sequentially output low-level or high-level potentials based on the bits D0, D1, ..., Dn-1, and Dn of the gradation data D, the capacitors C10, C11, ..., C1n-1, and C1n are sequentially driven by the potentials, and the capacitance drive circuit 20 outputs an inspection voltage that increases in a stepwise manner to the test node TEST_NODE1 via the switch SW2.

Comparing FIGS. 4 and 5, the amplitude of the inspection voltage of the test node TEST_NODE1 in FIG. 5 is larger than that in FIG. 4. That is, with the configuration according to the embodiment, the amplitude of the inspection voltage output to the test node TEST_NODE1 can be increased, and thus the inspection accuracy can be improved.

As described above, according to the driver 1 in the embodiment, the following effects can be attained.

The driver 1 serving as a drive circuit according to the embodiment includes: the output node NODE1 electrically coupled to the pixel P; the switch SW1 serving as a first switch having one end electrically coupled to the output node NODE1; n (n is an integer of 1 or more) capacitors C1 serving as n first capacitors each having one end electrically coupled to the other end of the switch SW1; the capacitor drive circuit 10 serving as a first capacitor drive circuit configured to drive the n capacitors C1 based on gradation data D serving as a video signal representing image information and electrically coupled to the other end of each of the n capacitors C1; the switch SW2 serving as a second switch having one end electrically coupled to the other end of the switch SW1 and the other end electrically coupled to the test node TEST_NODE1 serving as a first test node; the switch SW3 serving as a third switch having one end electrically coupled to the output node NODE1; m (m is an integer of 1 or more) switches SW4 serving as m fourth switches each having one end electrically coupled to the other end of the switch SW3; m capacitors C2 serving as m second capacitors each having one end electrically coupled to the other end of a respective one of the m switches SW4 and the other end to which a constant potential is applied; the switch SW5 serving as a fifth switch having one end electrically coupled to the other end of the switch SW3 and the other end electrically coupled to the test node TEST_NODE2 serving as a second test node.

In this way, the n capacitors C1 are electrically coupled between the switch SW1 and the switch SW2, and the m capacitors C2 are electrically coupled between the switch SW3 and the switch SW5.

Therefore, according to the embodiment, since the influence of the output node NODE1 and the influence of the m capacitors C2 can be eliminated when the n capacitors C1 are inspected, the amplitude of the inspection voltage output to the test node TEST_NODE1 can be increased. Therefore, according to the embodiment, the accuracy of the inspection can be improved. Similarly, since the influence of the output node NODE1 and the influence of the n capacitors C1 can be eliminated when the m capacitors C2 are inspected, the amplitude of the inspection voltage output to the test node TEST_NODE1 can be increased. Therefore, according to the embodiment, the accuracy of the inspection can be improved.

The driver 1 serving as a drive circuit according to the embodiment further includes: the switch SW6 serving as a sixth switch having one end electrically coupled to the output node NODE1; and the voltage drive circuit 40 electrically coupled to the other end of the switch SW6 and configured to output the first voltage V1 based on the video signal representing the image information. Therefore, it is possible to implement the driver 1 capable of driving with high accuracy.

The electro-optical device 100 according to the embodiment includes: the driver 1 serving as the drive circuit described above; and the electro-optical panel 2 including the pixel P and electrically coupled to the output node NODE1.

In this way, since the electro-optical device 100 according to the embodiment includes the driver 1 capable of performing a highly accurate inspection, it is possible to implement the electro-optical device 100 having high reliability.

### 2. Embodiment 2

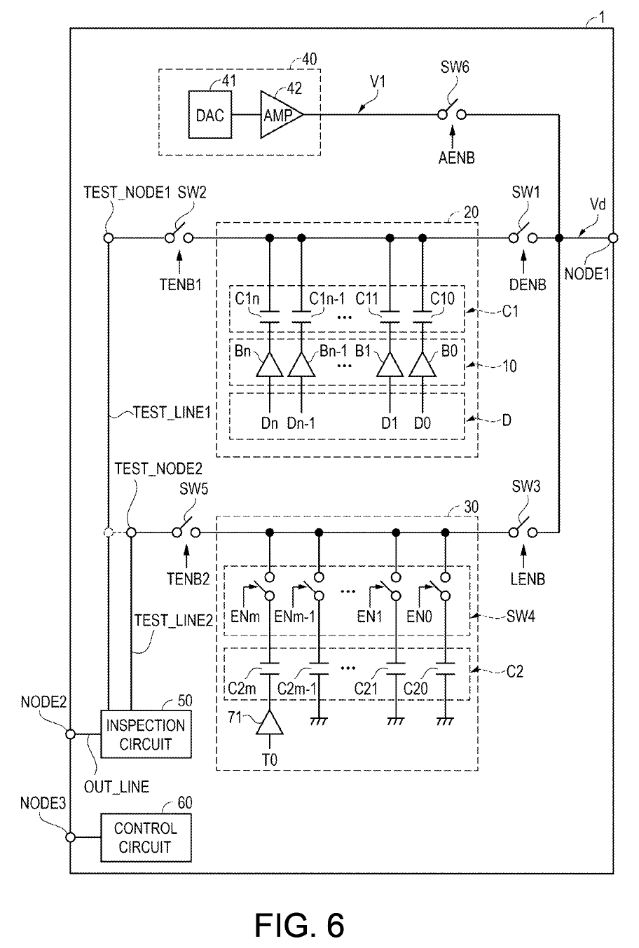

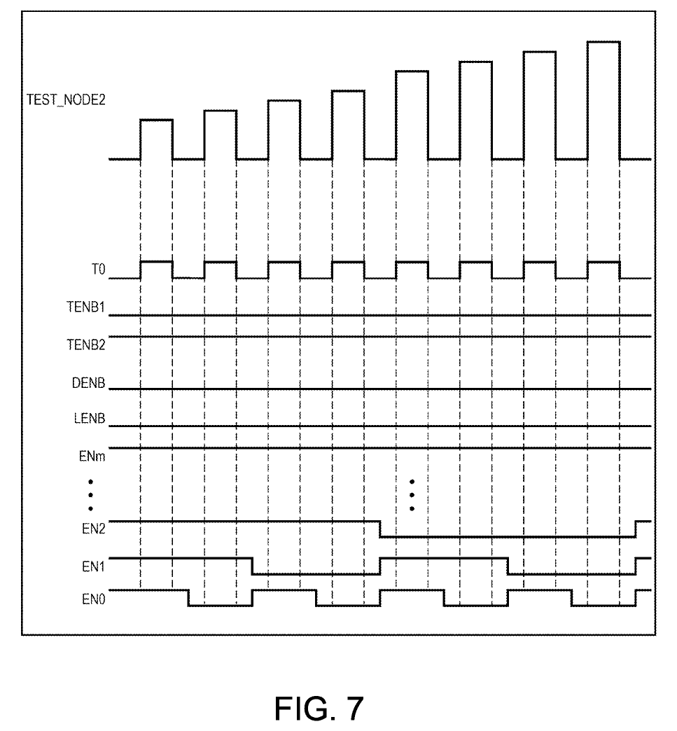

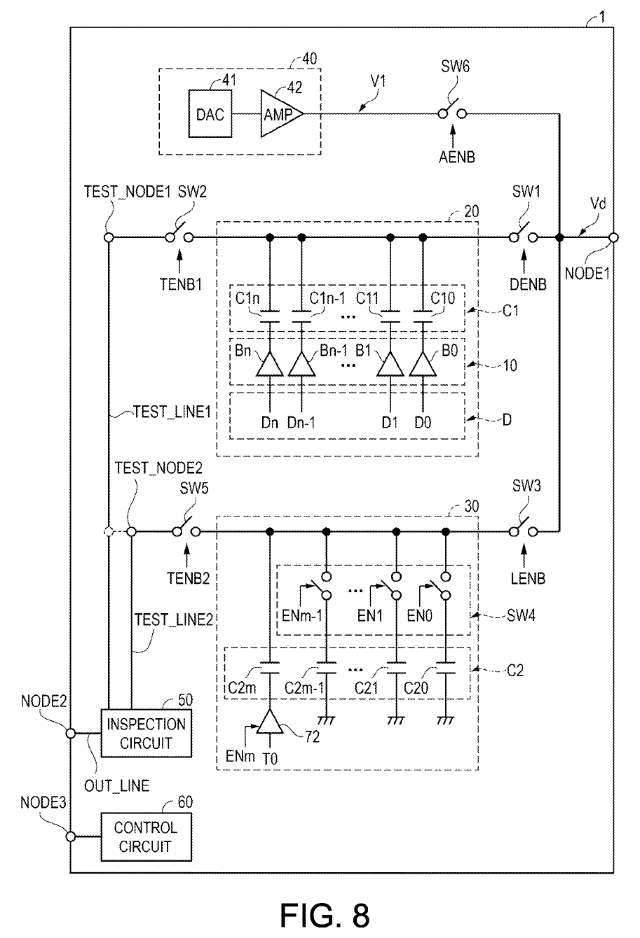

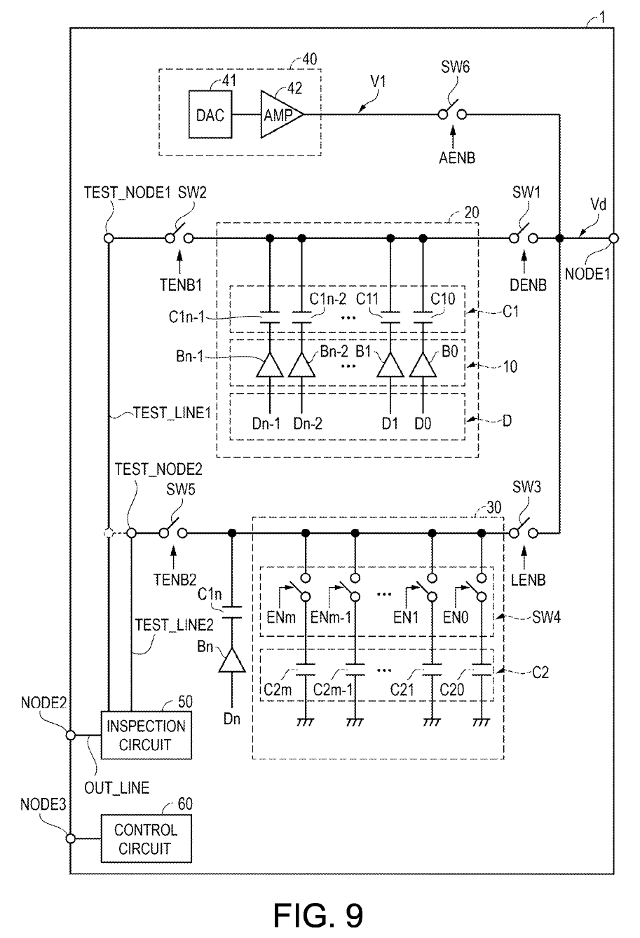

Next, the driver 1 according to Embodiment 2 will be described with reference to FIGS. 6 to 9. FIG. 6 is a circuit diagram of the driver 1 according to Embodiment 2. FIG. 7 is a timing chart showing an operation during inspection in the driver 1 according to Embodiment 2. FIG. 8 is a circuit diagram of the driver 1 according to Modification 1 of Embodiment 2. FIG. 9 is a circuit diagram of the driver 1 according to Modification 2 of Embodiment 2.

The driver 1 according to Embodiment 2 is different from the driver 1 according to Embodiment 1 in that the inspection voltage is output from the test node TEST_NODE2 when the balance capacitance circuit 30 is inspected. The same components as those of Embodiment 1 are denoted by the same signs, and the description thereof may be omitted.

As shown in FIG. 6, the driver 1 according to Embodiment 2 includes a buffer 71 in the balance capacitance circuit 30. One end of the buffer 71 is coupled to the capacitor C2m, and a drive signal T0 is supplied to the other end of the buffer 71.

As shown in FIG. 7, in the configuration according to Embodiment 2, when the balance capacitance circuit 30 is inspected, the switch SW5 is turned on and the switch SW1, the switch SW3, and the switch SW2 are turned off from the start to the end of the inspection. Therefore, the control signal TENB2 is set to the high level, and the control signal DENB, the control signal LENB, and the control signal TENB1 are set to the low level. The capacitance drive circuit 20 may be inspected simultaneously with the balance capacitance circuit 30. In this case, the switch SW1 is turned off, the switch SW2 is turned on, the control signal TENB1 is set to the high level, and the control signal DENB is set to the low level. When the capacitance drive circuit 20 and the balance capacitance circuit 30 are simultaneously inspected by the inspection circuit 50, the inspection circuit 50 may include a first inspection circuit that inspects the capacitance drive circuit 20 and a second inspection circuit that inspects the balance capacitance circuit 30.

When the inspection of the balance capacitance circuit 30 is started, the drive signal T0 that alternately repeats the high level and the low level is supplied from the control circuit 60 to the buffer 71. All the control signals EN0, EN1, ..., ENm-1, and ENm are set to the high level at the start of the inspection, and then the control signals EN0, EN1, ..., and ENm-1 alternately repeat the high level and the low level in a predetermined cycle. By this operation, the capacitance electrically coupled to the test node TEST_NODE2 decreases stepwise, and the amplitude of the inspection voltage output to the test node TEST_NODE2 increases stepwise each time the drive signal T0 becomes the high level. By comparing the inspection voltage with the reference voltage in the inspection circuit 50, the balance capacitance circuit 30 can be inspected.

### 2.1. Modification 1

As shown in FIG. 8, the driver 1 according to Modification 1 includes a clocked gate 72 instead of the buffer 71. The control signal ENm is supplied to the clocked gate 72.

The driver 1 according to Modification 1 can also be operated similarly to the driver 1 according to Embodiment 2, and the balance capacitance circuit 30 can be inspected.

### 2.2. Modification 2

As shown in FIG. 9, in the driver 1 according to Modification 2, a part of the capacitance drive circuit 20 is electrically coupled between the switch SW3 and the switch SW5 similarly to the balance capacitance circuit 30. Specifically, the capacitor C1n that outputs a low-level or high-level potential by the most significant bit Dn of the gradation data D and the drive unit Bn are electrically coupled between the switch SW3 and the switch SW5.

The driver 1 according to Modification 2 can also be operated in the same manner as the driver 1 according to Embodiment 2 and Modification 1, and the balance capacitance circuit 30 can be inspected.

As described above, according to the driver 1 in Embodiment 2, the following effects can be attained in addition to the effects of Embodiment 1.

The driver 1 serving as the drive circuit according to Embodiment 2 further includes the buffer 71 or the clocked gate 72 having one end electrically coupled to the other end of the switch SW3.

Therefore, since the driver 1 serving as the drive circuit according to Embodiment 2 can output the inspection voltage from the test node TEST_NODE2, it is possible to inspect the m capacitors C2.

### 3. Embodiment 3

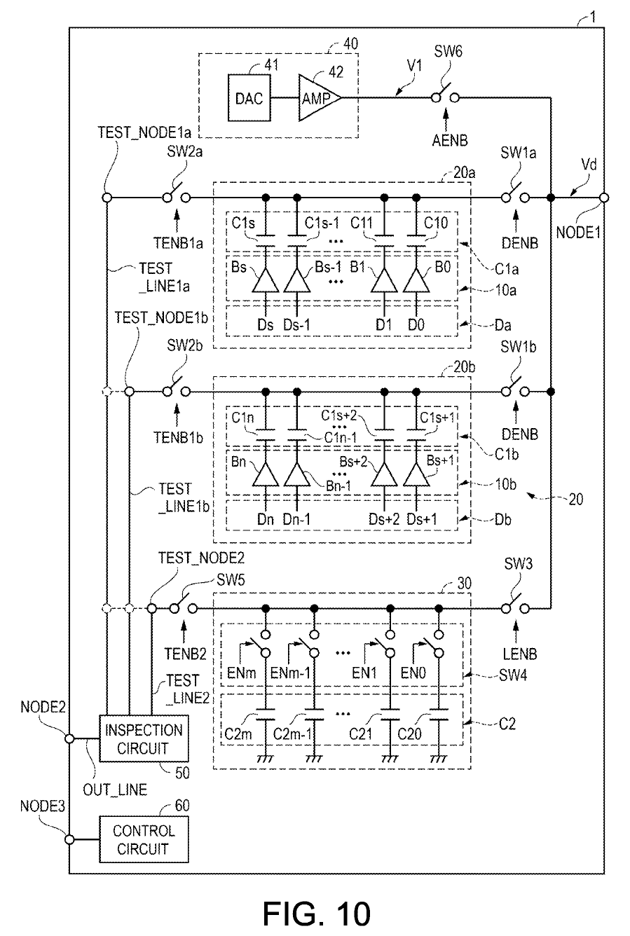

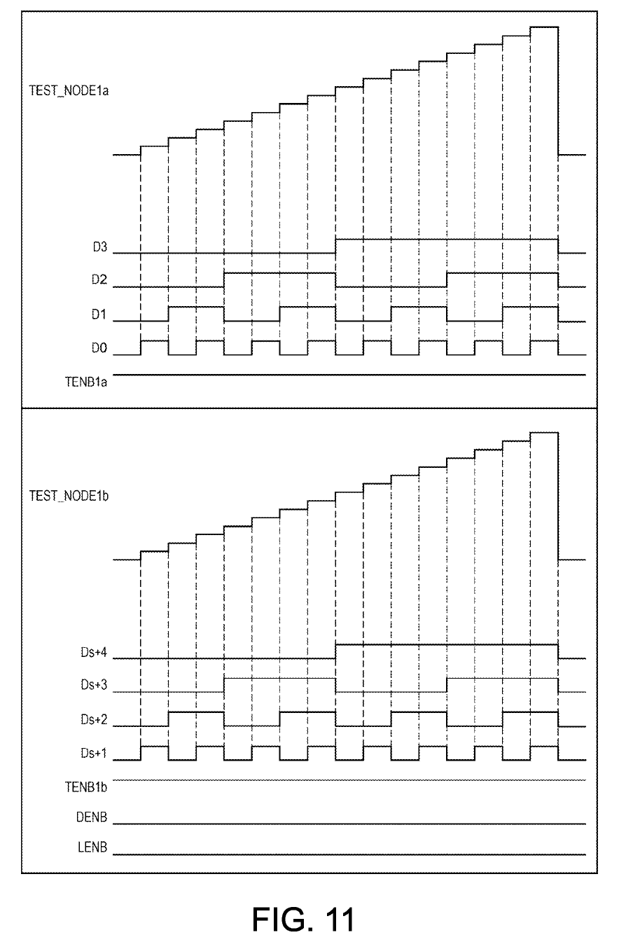

Next, the driver 1 according to Embodiment 3 will be described with reference to FIGS. 10 and 11. FIG. 10 is a circuit diagram of the driver 1 according to Embodiment 3. FIG. 11 is a timing chart showing an operation during inspection in the driver 1 according to Embodiment 3.

The driver 1 according to Embodiment 3 is different from the driver 1 according to Embodiment 1 and Embodiment 2 in that the capacitance drive circuit 20 is divided into two of a capacitance drive circuit 20a and a capacitance drive circuit 20b. The same components as those in Embodiment 1 and Embodiment 2 are denoted by the same signs, and the description thereof may be omitted.

The capacitance drive circuit 20a takes charge of the least significant bit side of the grayscale data D, and the capacitance drive circuit 20b takes charge of the most significant bit side of the grayscale data D. That is, the capacitance drive circuit 20a is implemented by portions corresponding to lower bits D0, D1, ..., Ds-1, and Ds of the gradation data D in the capacitance drive circuit 20 according to Embodiment 1, and the capacitance drive circuit 20b is implemented by portions corresponding to upper bits Ds+1, Ds+2, ..., Dn-1, and Dn of the gradation data D in the capacitance drive circuit 20 according to Embodiment 1. Here, s is an integer smaller than n.

In this way, in Embodiment 3, since the capacitance drive circuit 20 is divided into two of the capacitance drive circuit 20a and the capacitance drive circuit 20b on the least significant bit side and the most significant bit side of the gradation data D, the capacitance drive circuit 20a and the capacitance drive circuit 20b have a smaller difference between the capacitance for moving a large voltage and the capacitance for moving a small voltage than the capacitance drive circuit 20 according to Embodiment 1, and thus the difference in voltage is reduced. Therefore, the inspection accuracy can be improved. The number of divisions of the capacitance drive circuit 20 is not limited to two, and the capacitance drive circuit 20 may be divided into three or more.

In Embodiment 3, the capacitance drive circuit 20b is electrically separated from the capacitance drive circuit 20a when the capacitance drive circuit 20a is inspected. Therefore, the capacitance ratio between the overall capacitance of the capacitance drive circuit 20a, that is, the total capacitance of the s capacitors C1a, and the capacitance corresponding to the minimum bit D0 of the capacitance drive circuit 20a, that is, the capacitor C10 can be closer to 1 than the capacitance drive circuit 20 according to Embodiment 1. Specifically, when the gradation data D is 12bits, the capacitance ratio is 1/4096 in the capacitance drive circuit 20 according to Embodiment 1, whereas the capacitance ratio is 1/64 in the capacitance drive circuit 20a, and thus the capacitance ratio approaches 1. Therefore, it is possible to increase the amplitude of the voltage when the drive unit B0 electrically coupled to the capacitor C10 is driven, and it is possible to improve the inspection accuracy.

Similarly, when the capacitance drive circuit 20b is inspected, the capacitance drive circuit 20a is electrically separated from the capacitance drive circuit 20b. Therefore, the capacitance ratio between the overall capacitance of the capacitance drive circuit 20b, that is, the total capacitance of the n-s capacitors C1b, and the capacitance corresponding to the minimum bit Ds+1 of the capacitance drive circuit 20b, that is, a capacitor C1s+1 can be brought close to 1. Therefore, it is possible to increase the amplitude of the voltage when a drive unit Bs+1 electrically coupled to the capacitor C1s+1 is driven, and it is possible to improve the inspection accuracy.

As shown in FIG. 10, the capacitance drive circuit 20a is electrically coupled to the output node NODE1 via a switch SW1a. The capacitance drive circuit 20b is electrically coupled to the output node NODE1 via a switch SW1b. In the embodiment, the switch SW1a is an example of a seventh switch, and the switch SW1b is an example of a ninth switch.

When the driver 1 drives the electro-optical panel 2, the switch SW1a, the switch SW1b, and the switch SW3 are turned on in a first period, and are turned off in a second period after the first period. In contrast, the switch SW6 is turned off in the first period, and is turned on in the second period after the first period. That is, the driver 1 outputs the data voltage Vd by capacitive driving by the capacitance drive circuits 20a and 20b in the first period, and outputs the data voltage Vd by voltage driving by the voltage drive circuit 40 in the second period after the first period. Under the control, it is possible to drive the driver 1 at a high speed with high accuracy.

The control signal DENB is supplied from the control circuit 60 to the control terminals of the switch SW1a and the switch SW1b. That is, the capacitance drive circuit 20a and the capacitance drive circuit 20b are electrically coupled to the output node NODE1 in the first period.

The capacitance drive circuit 20a is electrically coupled to a test node TEST_NODE1a via a switch SW2a. The capacitance drive circuit 20b is electrically coupled to a test node TEST_NODE1b via a switch SW2b. That is, the capacitance drive circuit 20a and the capacitance drive circuit 20b are coupled to different test nodes. Therefore, the driver 1 can inspect the capacitance drive circuit 20a and the capacitance drive circuit 20b in parallel, and the inspection speed can be improved. In the embodiment, the switch SW2a is an example of an eighth switch, and the switch SW2b is an example of a tenth switch. The capacitance drive circuit 20b may be electrically coupled to the test node TEST_NODE1a via the switch SW2b. Since the configuration of the circuit such as wiring can be reduced, miniaturization and cost reduction can be achieved.

The test node TEST_NODE1a is electrically coupled to the inspection circuit 50 via a test line TEST_LINE1a. The test node TEST_NODE1b is electrically coupled to the inspection circuit 50 via a test line TEST_LINE1b.

When the inspection circuit 50 inspects the capacitance drive circuit 20a, the switch SW2a is turned on and the switch SW1a is turned off. That is, since the capacitance drive circuit 20a is separated from the output node NODE1, the influence of the output node NODE1, for example, the influence of a voltage change or parasitic capacitance can be eliminated when the capacitance drive circuit 20a is inspected, and thus the inspection accuracy can be improved. Further, the switch SW5 is turned off. Since the influence of the balance capacitance circuit 30 can be eliminated by turning off the switch SW5, the inspection accuracy can be improved.

A control signal TENB1a is supplied from the control circuit 60 to the control terminal of the switch SW2a, and a control signal TENB1b is supplied from the control circuit 60 to the control terminal of the switch SW2b. That is, on/off of the switch SW2a and the switch SW2b is controlled by the control circuit 60.

The capacitance drive circuit 20a includes s capacitors C1a and a capacitor drive circuit 10a that drives the s capacitors C1a based on a video signal of a lower bit of a video signal representing image information. In the embodiment, the s capacitors C1a are an example of s third capacitors, and the capacitor drive circuit 10a is an example of a second capacitor drive circuit.

The capacitance drive circuit 20b includes n-s capacitors C1b and a capacitor drive circuit 10b that drives the n-s capacitors C1b based on a video signal of an upper bit of a video signal representing image information. In the embodiment, the n-s capacitors C1b are an example of n-s fourth capacitors, and the capacitor drive circuit 10b is an example of a third capacitor drive circuit.

The s capacitors C1a include capacitors C10, C11, ..., C1s-1, and C1s. One end of each of the s capacitors C1a is electrically coupled to the other end of the switch SW1a.

The capacitor drive circuit 10a includes s drive units B0, B1, ..., Bs-1, and Bs. One end of each of the s drive units B0, B1, ..., Bs-1, and Bs of the capacitor drive circuit 10a is electrically coupled to the other end of a respective one of the s capacitors C1a.

The n-s capacitors C1b include capacitors C1s+1, C1s+2, ..., C1n-1, and C1n. One end of each of the n-s capacitors C1b is electrically coupled to the other end of the switch SW1b.

The capacitor drive circuit 10b includes n-s drive units Bs+1, Bs+2, ..., Bn-1, and Bn. One end of each of the n-s drive units Bs+1, Bs+2, ..., Bn-1, and Bn of the capacitor drive circuit 10b is electrically coupled to the other end of a respective one of the n-s capacitors C1b.

In the capacitance drive circuit 20a, the switch SW2a is turned on and the switch SW1a is turned off during inspection. In the capacitance drive circuit 20b, the switch SW2b is turned on and the switch SW1b is turned off during inspection. That is, during inspection, the capacitance drive circuit 20a and the capacitance drive circuit 20b are electrically separated.

Therefore, when the capacitance drive circuit 20a and the capacitance drive circuit 20b are inspected, the capacitance ratio of the capacitances of the capacitors C10, C11, ..., C1s-1, and C1s in the s capacitors C1a is the same as the capacitance ratio of the capacitances of the capacitors C1s+1, C1s+2, ..., C1n-1, and C1n in the n-s capacitors C1b. Therefore, as shown in the timing chart of FIG. 11, inspection voltages having similar waveforms are detected from the test node TEST_NODE1a and the test node TEST_NODE1b. Similarly to the driver 1 according to Embodiment 1 and the driver 1 according to Embodiment 2, when the inspection circuit 50 includes the first inspection circuit, the second inspection circuit, and the third inspection circuit that inspect the capacitance drive circuit 20a, the capacitance drive circuit 20b, and the balance capacitance circuit 30, respectively, the inspection may be performed at the same time.

As described above, according to the driver 1 in Embodiment 3, the following effects can be attained in addition to the effects of Embodiment 1 and Embodiment 2.

The driver 1 serving as the drive circuit according to Embodiment 3 includes: the output node NODE1 electrically coupled to the pixel P; the switch SW1a serving as a seventh switch having one end electrically coupled to the output node NODE1; s (s is an integer of 1 or more) capacitors C1a serving as s third capacitors having one end electrically coupled to the other end of the switch SW1a; the capacitor drive circuit 10a serving as a second capacitor drive circuit configured to drive the s capacitors C1a based on a video signal of a lower bit of gradation data D serving as a video signal representing image information and electrically coupled to the other end of each of the s capacitors C1a; the switch SW2a serving as an eighth switch having one end electrically coupled to the other end of the switch SW1a and the other end electrically coupled to the test node TEST_NODE1a serving as a third test node; the switch SW1b serving as a ninth switch having one end electrically coupled to the output node NODE1; n-s (n is an integer larger than s) capacitors C1b serving as n-s fourth capacitors each having one end electrically coupled to the other end of the switch SW1b; the capacitor drive circuit 10b serving as a third capacitor drive circuit configured to drive the n-s capacitors C1b based on a video signal of an upper bit of the gradation data D serving as the video signal representing the image information and electrically coupled to the other end of each of the n-s capacitors C1b; the switch SW2b serving as a tenth switch having one end electrically coupled to the other end of the switch SW1b and the other end electrically coupled to the test node TEST_NODE1b serving as a fourth test node; the switch SW3 serving as a third switch having one end electrically coupled to the output node NODE1; m (m is an integer of 1 or more) switches SW4 serving as m fourth switches each having one end electrically coupled to the other end of the switch SW3; m capacitors C2 serving as m second capacitors each having one end electrically coupled to the other end of a respective one of the m switches SW4 and the other end to which a constant potential is applied; and the switch SW5 serving as a fifth switch having one end electrically coupled to the other end of the switch SW3 and the other end electrically coupled to the test node TEST_NODE2 serving as a second test node.

In this way, the s capacitors C1a are electrically coupled between the switch SW1a and the switch SW2a, the n-s capacitors C1b are electrically coupled between the switch SW1b and the switch SW2b, and the m capacitors C2 are electrically coupled between the switch SW3 and the switch SW5.

Therefore, according to Embodiment 3, since the influence of the output node NODE1, the influence of the n-s capacitors C1b, and the influence of the m capacitors C2 can be eliminated when the s capacitors C1a are inspected, the amplitude of the inspection voltage output to the test node TEST_NODE1a can be increased. Therefore, according to Embodiment 3, the accuracy of the inspection can be improved.

Similarly, since the influence of the output node NODE1, the influence of the s capacitors C1a, and the influence of the m capacitors C2 can be eliminated when the n-s capacitors C1b are inspected, the amplitude of the inspection voltage output to the test node TEST_NODE1b can be increased. Therefore, according to Embodiment 3, the accuracy of the inspection can be improved.

Similarly, since the influence of the output node NODE1, the influence of the s capacitors C1a, and the influence of the n-s capacitors C1b can be eliminated when the m capacitors C2 are inspected, the amplitude of the inspection voltage output to the test node TEST_NODE2 can be increased. Therefore, according to Embodiment 3, the accuracy of the inspection can be improved.

In Embodiment 3, since the s capacitors C1a correspond to the least significant bit side of the gradation data D and the n-s capacitors C1b correspond to the most significant bit side of the gradation data D, the difference in capacitance is reduced in each of the s capacitors C1a and the n-s capacitors C1b, and thus the difference in voltage is reduced. Therefore, the inspection accuracy can be improved.

### 4. Embodiment 4

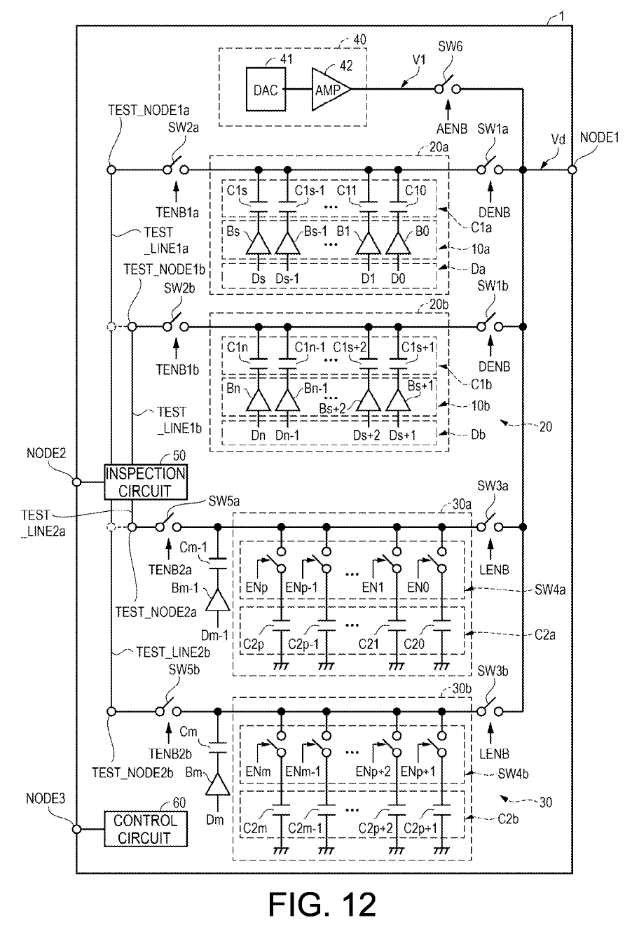

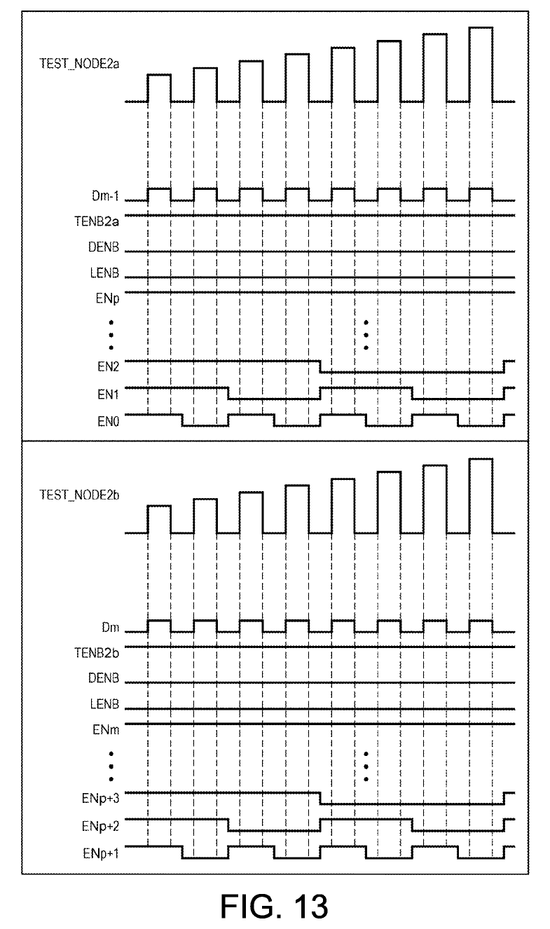

Next, the driver 1 according to Embodiment 4 will be described with reference to FIGS. 12 and 13. FIG. 12 is a circuit diagram of the driver 1 according to Embodiment 4. FIG. 13 is a timing chart showing an operation during inspection in the driver 1 according to Embodiment 4.

As shown in FIG. 12, the driver 1 according to Embodiment 4 is different from the driver 1 according to Embodiment 3 in that the balance capacitance circuit 30 is divided into two of a balance capacitance circuit 30a and a balance capacitance circuit 30b. The same components as those in Embodiment 1, Embodiment 2, and Embodiment 3 are denoted by the same signs, and the description thereof may be omitted.

In Embodiment 4, since the balance capacitance circuit 30 is divided into two of the balance capacitance circuit 30a and the balance capacitance circuit 30b, the balance capacitance circuit 30a and the balance capacitance circuit 30b have a capacitance ratio between a large capacitance and a small capacitance closer to 1 than the balance capacitance circuit 30 according to Embodiment 1, and thus the difference between the inspection voltages is reduced. Therefore, the inspection accuracy can be improved.

In Embodiment 4, similarly to the driver 1 according to Modification 2 of Embodiment 2 described above, a part of the capacitance drive circuit 20b is electrically coupled between a switch SW3a and a switch SW5a and between a switch SW3b and a switch SW5b. Specifically, a capacitor Cm-1 corresponding to an upper bit Dm-1 of the gradation data D and a drive unit Bm-1 are electrically coupled between the switch SW3a and the switch SW5a, and a capacitor Cm corresponding to an upper bit Dm of the gradation data D and a drive unit Bm are electrically coupled between the switch SW3b and the switch SW5b.

The driver 1 according to Embodiment 4 can be operated similarly to the driver 1 according to Modification 2 of Embodiment 2, and the balance capacitance circuit 30a and the balance capacitance circuit 30b can be separately inspected.

As shown in FIG. 13, when the inspection of the balance capacitance circuit 30a is started, the control signals LENB and DENB are set to the low level, and a control signal TENB2a is set to the high level. Accordingly, the balance capacitance circuit 30ais electrically separated from the output node NODE1 and is electrically coupled to a test node TEST_NODE2a.

The bit Dm-1 that alternately repeats a high level and a low level is supplied from the control circuit 60 to the drive unit Bm-1. All the control signals EN0, EN1, ..., ENp-1, and ENp are set to the high level at the start of the inspection, and then the control signals EN0, EN1, ..., and ENp-1 alternately repeat the high level and the low level in a predetermined cycle. By this operation, the capacitance electrically coupled to the test node TEST_NODE2a decreases stepwise, and the amplitude of the inspection voltage output to the test node TEST_NODE2a increases stepwise each time the bit Dm-1 becomes the high level. By comparing the inspection voltage with the reference voltage in the inspection circuit 50, the balance capacitance circuit 30a can be inspected.

Similarly, when the inspection of the balance capacitance circuit 30b is started, the control signals LENB and DENB are set to the low level, and a control signal TENB2b is set to the high level. Accordingly, the balance capacitance circuit 30b is electrically separated from the output node NODE1 and is electrically coupled to a test node TEST_NODE2b.

The bit Dm that alternately repeats a high level and a low level is supplied from the control circuit 60 to the drive unit Bm. All control signals ENp+1, ENp+2, ..., ENm-1, and ENm are set to the high level at the start of the inspection, and then the control signals ENp+1, ENp+2, ..., and ENm-1 alternately repeat the high level and the low level in a predetermined cycle. By this operation, the capacitance electrically coupled to the test node TEST_NODE2b decreases stepwise, and the amplitude of the inspection voltage output to the test node TEST_NODE2b increases stepwise each time the bit Dm becomes the high level. By comparing the inspection voltage with the reference voltage in the inspection circuit 50, the balance capacitance circuit 30b can be inspected.

The test node TEST_NODE2a is electrically coupled to the inspection circuit 50 via a test line TEST_LINE2a. The test node TEST_NODE2b is electrically coupled to the inspection circuit 50 via a test line TEST_LINE2b. The balance capacitance circuit 30a may be electrically coupled to the test node TEST_NODE1b via the switch SW5a. Since the configuration of the circuit such as wiring can be reduced, miniaturization and cost reduction can be achieved. Similarly to the driver 1 according to Embodiment 1, the driver 1 according to Embodiment 2, and the driver 1 according to Embodiment 3, when the inspection circuit 50 includes the first inspection circuit, the second inspection circuit, the third inspection circuit, and the fourth inspection circuit that inspect the capacitance drive circuit 20a, the capacitance drive circuit 20b, the balance capacitance circuit 30a, and the balance capacitance circuit 30b, respectively, the inspection may be performed at the same time.

As described above, according to the driver 1 in Embodiment 4, the following effects can be attained in addition to the effects of Embodiment 1, Embodiment 2, and Embodiment 3.

The driver 1 serving as the drive circuit according to Embodiment 4 includes: the output node NODE1 electrically coupled to the pixel P; the switch SW1a serving as a seventh switch having one end electrically coupled to the output node NODE1; s (s is an integer of 1 or more) capacitors C1a serving as s third capacitors each having one end electrically coupled to the other end of the switch SW1a; the capacitor drive circuit 10a serving as a second capacitor drive circuit configured to drive the s capacitors C1a based on a video signal of a lower bit of gradation data D serving as a video signal representing image information and electrically coupled to the other end of each of the s capacitors C1a; the switch SW2a serving as an eighth switch having one end electrically coupled to the other end of the switch SW1a and the other end electrically coupled to the test node TEST_NODE1a serving as a third test node; a switch SW1b serving as a ninth switch having one end electrically coupled to the output node NODE1; n-s (n is an integer larger than s) capacitors C1b serving as n-s fourth capacitors each having one end electrically coupled to the other end of the switch SW1b; the capacitor drive circuit 10b serving as a third capacitor drive circuit configured to drive the n-s capacitors C1b based on a video signal of an upper bit of the gradation data D serving as the video signal representing the image information and electrically coupled to the other end of each of the n-s capacitors C1b; the switch SW2b serving as a tenth switch having one end electrically coupled to the other end of the switch SW1b and the other end electrically coupled to the test node TEST_NODE1b serving as a fourth test node; the switch SW3a serving as an eleventh switch having one end electrically coupled to the output node NODE1; p (p is an integer of 1 or more) switches SW4a serving as twelfth switches each having one end electrically coupled to the other end of the switch SW3a; p capacitors C2a serving as p fifth capacitors each having one end electrically coupled to the other end of a respective one of the p switches SW4a and the other end to which a constant potential is applied; the switch SW5a serving as a thirteenth switch having one end electrically coupled to the other end of each of the switches SW4a and the other end electrically coupled to the test node TEST_NODE2a serving as a fifth test node; the switch SW3b serving as a fourteenth switch having one end electrically coupled to the output node NODE1; m-p (m is an integer larger than p) switches SW4b serving as m-p fifteenth switches each having one end electrically coupled to the other end of the switch SW3b; m-p capacitors C2b serving as m-p sixth capacitors each having one end electrically coupled to the other end of a respective one of the m-p switches SW4b and the other end to which a constant potential is applied; the switch SW5b serving as a sixteenth switch having one end electrically coupled to the other end of each of the m-p switches SW4b and the other end electrically coupled to the test node TEST_NODE2b serving as a sixth test node.

In this way, the s capacitors C1a are electrically coupled between the switch SW1a and the switch SW2a, the n-s capacitors C1b are electrically coupled between the switch SW1b and the switch SW2b, the p capacitors C2a are electrically coupled between the switch SW3a and the switch SW5a, and the m-p capacitors C2b are electrically coupled between the switch SW3b and the switch SW5b.

Therefore, according to Embodiment 4, since the influence of the output node NODE1, the influence of the n-s capacitors C1b, the influence of the p capacitors C2a, and the influence of the m-p capacitors C2b can be eliminated when the s capacitors C1a are inspected, the amplitude of the inspection voltage output to the test node TEST_NODE1a can be increased. Therefore, according to Embodiment 4, the accuracy of the inspection can be improved.

Similarly, since the influence of the output node NODE1, the influence of the s capacitors C1a, the influence of the p capacitors C2a, and the influence of the m-p capacitors C2b can be eliminated when the n-s capacitors C1b are inspected, the amplitude of the inspection voltage output to the test node TEST_NODE1b can be increased. Therefore, according to Embodiment 4, the accuracy of the inspection can be improved.

Similarly, since the influence of the output node NODE1, the influence of the s capacitors C1a, the influence of the n-s capacitors C1b, and the influence of the m-p capacitors C2b can be eliminated when the p capacitors C2a are inspected, the amplitude of the inspection voltage output to the test node TEST_NODE2a can be increased. Therefore, according to Embodiment 4, the accuracy of the inspection can be improved.

Similarly, since the influence of the output node NODE1, the influence of the s capacitors C1a, the influence of the n-s capacitors C1b, and the influence of the p capacitors C2a can be eliminated when the m-p capacitors C2b are inspected, the amplitude of the inspection voltage output to the test node TEST_NODE2b can be increased. Therefore, according to Embodiment 4, the accuracy of the inspection can be improved.

In Embodiment 4, since the s capacitors C1a correspond to the least significant bit side of the gradation data D and the n-s capacitors C1b correspond to the most significant bit side of the gradation data D, the difference in capacitance is reduced in each of the s capacitors C1a and the n-s capacitors C1b, and thus the difference in voltage is reduced. Therefore, the inspection accuracy can be improved.

In Embodiment 4, since the capacitor is divided into the p capacitors C2a and the m-p capacitors C2b, the difference in capacitance is reduced in each of the p capacitors C2a and the m-p capacitors C2b, and thus the difference in voltage is reduced. Therefore, the inspection accuracy can be improved.

The driver 1 serving as the drive circuit according to Embodiment 4 further includes: the drive unit Bm-1 having one end electrically coupled to the other end of the switch SW5a serving as the thirteenth switch; and the drive unit Bm having one end electrically coupled to the other end of the switch SW5b serving as the sixteenth switch.

Therefore, since the driver 1 serving as the drive circuit according to Embodiment 4 can output the inspection voltage from the test node TEST_NODE2a, the p capacitors C2a can be inspected, and since the inspection voltage can be output from the test node TEST_NODE2b, the m-p capacitors C2b can be inspected.

Although the preferred embodiments have been described above, the present disclosure is not limited to the embodiments described above. In addition, the configuration of each unit according to the present disclosure can be replaced with any configuration that exhibits the same function as that of the embodiments described above, and any configuration can be added. For example, in the embodiments described above, the switch is set to the on operation state when the control signal is at the high level. Alternatively, the switch may be set to the on operation state when the control signal is at the low level. When the switch is set to the on operation state when the control signal is at the low level, the description of the high level and the low level of the control signal described in the embodiments described above is reversed.

What is claimed is:

1. A drive circuit comprising:
an output node electrically coupled to a pixel;
a first switch having one end electrically coupled to the output node;
n first capacitors each having one end electrically coupled to the other end of the first switch, and n is an integer of 1 or more;
a first capacitor drive circuit configured to drive the n first capacitors based on a video signal representing image information and electrically coupled to the other end of each of the n first capacitors;
a second switch having one end electrically coupled to the other end of the first switch and the other end electrically coupled to a first test node;
a third switch having one end electrically coupled to the output node;
m fourth switches each having one end electrically coupled to the other end of the third switch, and m is an integer of 1 or more;
m second capacitors each having one end electrically coupled to the other end of a respective one of the m fourth switches and the other end to which a constant potential is applied; and
a fifth switch having one end electrically coupled to the other end of the third switch and the other end electrically coupled to a second test node.

2. The drive circuit according to claim 1, further comprising:
a sixth switch having one end electrically coupled to the output node; and
a voltage drive circuit electrically coupled to the other end of the sixth switch and configured to output a first voltage based on the video signal representing the image information.

3. The drive circuit according to claim 1, further comprising
a buffer or a clocked gate having one end electrically coupled to the other end of the third switch.

4. A drive circuit comprising:
an output node electrically coupled to a pixel;
a seventh switch having one end electrically coupled to the output node;
s third capacitors each having one end electrically coupled to the other end of the seventh switch, and s is an integer of 1 or more;
a second capacitor drive circuit configured to drive the s third capacitors based on a lower bit of a video signal representing image information and electrically coupled to the other end of each of the s third capacitors;
an eighth switch having one end electrically coupled to the other end of the seventh switch and the other end electrically coupled to a third test node;
a ninth switch having one end electrically coupled to the output node;
n-s fourth capacitors each having one end electrically coupled to the other end of the ninth switch, and n is an integer larger than s;
a third capacitor drive circuit configured to drive the n-s fourth capacitors based on an upper bit of the video signal representing the image information and electrically coupled to the other end of each of the n-s fourth capacitors;
a tenth switch having one end electrically coupled to the other end of the ninth switch and the other end electrically coupled to a fourth test node;
a third switch having one end electrically coupled to the output node;
m fourth switches each having one end electrically coupled to the other end of the third switch, and m is an integer of 1 or more;
m second capacitors each having one end electrically coupled to the other end of a respective one of the m fourth switches and the other end to which a constant potential is applied; and
a fifth switch having one end electrically coupled to the other end of the third switch and the other end electrically coupled to a second test node.

5. A drive circuit comprising:
an output node electrically coupled to a pixel;
a seventh switch having one end electrically coupled to the output node;
s third capacitors each having one end electrically coupled to the other end of the seventh switch, and s is an integer of 1 or more;
a second capacitor drive circuit configured to drive the s third capacitors based on a lower bit of a video signal representing image information and electrically coupled to the other end of each of the s third capacitors;
an eighth switch having one end electrically coupled to the other end of the seventh switch and the other end electrically coupled to a third test node;
a ninth switch having one end electrically coupled to the output node;
n-s fourth capacitors each having one end electrically coupled to the other end of the ninth switch, and n is an integer larger than s;
a third capacitor drive circuit configured to drive the n-s fourth capacitors based on an upper bit of the video signal representing the image information and electrically coupled to the other end of each of the n-s fourth capacitors;
a tenth switch having one end electrically coupled to the other end of the ninth switch and the other end electrically coupled to a fourth test node;
an eleventh switch having one end electrically coupled to the output node;
p twelfth switches each having one end electrically coupled to the other end of the eleventh switch, and p is an integer of 1 or more;
p fifth capacitors each having one end electrically coupled to the other end of a respective one of the p twelfth switches and the other end to which a constant potential is applied;
a thirteenth switch having one end electrically coupled to the other end of the twelfth switch and the other end electrically coupled to a fifth test node;
a fourteenth switch having one end electrically coupled to the output node;
m-p fifteenth switches each having one end electrically coupled to the other end of the fourteenth switch, and m is an integer larger than p;
m-p sixth capacitors each having one end electrically coupled to the other end of a respective one of the m-p fifteenth switches and the other end to which a constant potential is applied; and
a sixteenth switch having one end electrically coupled to the other end of the fifteenth switch and the other end electrically coupled to a sixth test node.

6. The drive circuit according to claim 5, further comprising:
a drive unit having one end electrically coupled to the other end of the thirteenth switch; and
a drive unit having one end electrically coupled to the other end of the sixteenth switch.

7. An electro-optical device comprising:
the drive circuit according to claim 1; and
an electro-optical panel including the pixel and electrically coupled to the output node.
